(19) United States
(12) Patent Application Publication
(10) Pub. No.: US 2026/0241405 A1
(43) Pub. Date: Aug. 20, 2026

(54) COATING APPARATUS AND COATING METHOD

(71) Applicant: KYOCERA Corporation, Kyoto (JP)

(72) Inventors: Atsushi ISHIHARA, Kirishima-shi, Kagoshima (JP); Daisuke HOZUMI, Kirishima-shi, Kagoshima (JP); Takashi MIYAHARA, Kirishima-shi, Kagoshima (JP)

(21) Appl. No.: 18/851,689

(22) PCT Filed: Mar. 24, 2023
(86) PCT No.: PCT/JP2023/011840

§ 371 Date: Sep. 27, 2024

(30) Foreign Application Priority Data
Mar. 28, 2022 (JP) 2022-051340

(51) Int. Cl. B05B 13/04; B05B 12/00; B05B 12/08; B05B 13/00; B05B 15/58; B05D 1/02

(52) U.S. Cl. CPC B05B 13/0431; B05B 12/006; B05B 12/085; B05B 13/002; B05B 15/58; B05D 1/02

(57) ABSTRACT

A coating apparatus includes a reserve portion, a robot unit, first and second channels, an acquiring unit, and a controller. The reserve portion reserves liquid to be supplied to a liquid droplet discharge portion. The robot unit performs operations of the liquid droplet discharge portion. Through the first channel causing the liquid reserved in the reserve portion to flow into the liquid droplet discharge portion, the reserve portion and the liquid droplet discharge portion are communicated. Through the second channel causing the liquid flowed into the liquid droplet discharge portion to flow back to the reserve portion, the reserve portion and the liquid droplet discharge portion are communicated. The acquiring unit acquires information on operations of the liquid droplet discharge portion from program controlling the robot unit. The controller controls pressure of the liquid circulating between the reserve portion and the liquid droplet discharge portion, based on the information.

### CROSS-REFERENCE TO RELATED APPLICATIONS

This application is national stage application of International Application No. PCT/JP2023/011840, filed on Mar. 24, 2023, which designates the United States, and which claims the benefit of priority from Japanese Patent Application No. 2022-051340, filed on Mar. 28, 2022.

### DESCRIPTION

### Technical Field

Disclosed embodiments relate to a coating apparatus and a coating method.

### Background of Invention

Inkjet printers and inkjet plotters utilizing an inkjet recording method are known as printing devices. A droplet discharge head for discharging liquid is installed in such printing devices utilizing an inkjet method.

For inkjet printing devices, a technique of controlling the pressure of a liquid supplied to a liquid droplet discharge head has been proposed.

### CITATION LIST

### Patent Literature

Patent Document 1: JP 2010-12432 A

### SUMMARY

In one aspect of an embodiment, a coating apparatus includes a reserve portion, a robot unit, a first channel, a second channel, an acquiring unit, and a controller. The reserve portion reserves a liquid to be supplied to a liquid droplet discharge portion. The robot unit operates the liquid droplet discharge portion. The first channel is a channel through which the reserve portion and the liquid droplet discharge portion are in communication with each other, the channel being configured to cause the liquid reserved in the reserve portion to flow into the liquid droplet discharge portion. The second channel is a channel through which the reserve portion and the liquid droplet discharge portion are in communication with each other, the channel being configured to cause the liquid having flowed into the liquid droplet discharge portion to flow back to the reserve portion. The acquiring unit acquires information related to an operation of the liquid droplet discharge portion from a program controlling an operation of the robot unit. The controller controls a circulation pressure of the liquid circulating between the reserve portion and the liquid droplet discharge portion. The controller controls the circulation pressure, based on the information related to the operation.

### BRIEF DESCRIPTION OF THE DRAWINGS

FIG. 1 is a diagram illustrating an example of an outer appearance configuration of a liquid droplet discharge system according to an embodiment.

FIG. 2 is a diagram for describing changes in the pressure of a liquid inside a liquid droplet discharge head according to the embodiment.

FIG. 3 is a perspective view schematically illustrating an outer appearance configuration of the liquid droplet discharge head according to the embodiment.

FIG. 4 is a plan view illustrating the liquid droplet discharge head according to the embodiment.

FIG. 5 is a diagram schematically illustrating a channel inside the liquid droplet discharge head according to the embodiment.

FIG. 6 is a block diagram illustrating an example of a functional configuration of the liquid droplet discharge system according to the embodiment.

FIG. 7 is a diagram schematically illustrating a circulation mechanism of a circulation device in the liquid droplet discharge system according to the embodiment.

FIG. 8 is a diagram illustrating an overview of pressure adjustment information according to the embodiment.

FIG. 9 is a diagram for describing a method of controlling a first proportional valve and a second proportional valve based on the position of the liquid droplet discharge head according to the embodiment.

FIG. 10 is a diagram for describing the method of controlling the first proportional valve and the second proportional valve based on vertical acceleration acting on the liquid droplet discharge head according to the embodiment.

FIG. 11 is a diagram for describing the method of controlling the first proportional valve and the second proportional valve based on horizontal acceleration acting on the liquid droplet discharge head according to the embodiment.

FIG. 12 is a flowchart illustrating an example of a processing procedure of the liquid droplet discharge system according to the embodiment.

FIG. 13 is a block diagram illustrating an example of a functional configuration of a liquid droplet discharge system according to another embodiment.

FIG. 14 is a diagram illustrating an outline of second pressure adjustment information according to such another embodiment.

FIG. 15 is a flowchart illustrating an example of a processing procedure of the liquid droplet discharge system according to such another embodiment.

### DESCRIPTION OF EMBODIMENTS

Embodiments of a coating apparatus and a coating method disclosed in the present application will be described below with reference to the accompanying drawings. Note that the present disclosure is not limited by the following embodiments. Note that the drawings are schematic and that the dimensional relationships between elements, the proportions of the elements, and the like may differ from the actual ones. There may be differences between the drawings in terms of dimensional relationships, proportions, and the like.

Embodiments can be appropriately combined so as not to contradict each other in terms of processing content. In the following embodiments, the same portions are denoted by the same reference signs, and redundant explanations are omitted.

The following embodiment describes, as an example of the coating device disclosed by the present application, a liquid droplet discharge system in which a liquid droplet discharge head that discharges liquid (or a liquid droplet) by using an inkjet method is mounted on a robotic arm. The coating device disclosed by the present application can be applied to inkjet printers and inkjet plotters that utilize an inkjet recording method as well as various devices that discharge liquid (or liquid droplet) by using an inkjet method.

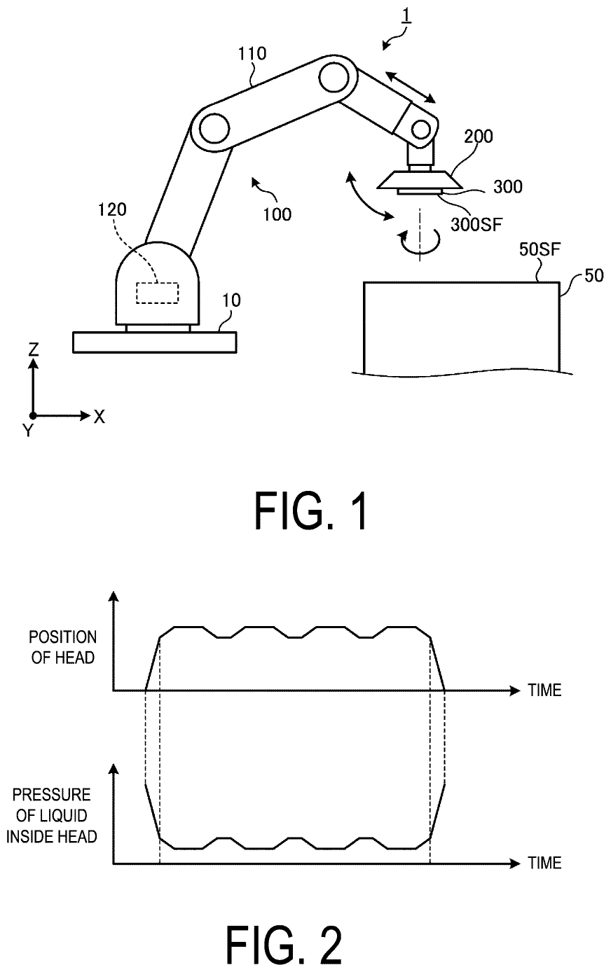

Example of Outer Appearance Configuration of Liquid Droplet Discharge System An outer appearance configuration of a liquid droplet discharge system according to an embodiment will be described with reference to FIG. 1. FIG. 1 is a diagram illustrating an example of an outer appearance configuration of the liquid droplet discharge system according to the embodiment.

As illustrated in FIG. 1, a liquid droplet discharge system 1 includes a robotic arm (an example of a robot unit) 100, a control unit 120. a circulation device 200, and a liquid droplet discharge head 300.

The robotic arm 100 is assembled on a base 10 mounted on, for example, a horizontal floor surface indoors or outdoors. The robotic arm 100 includes an arm portion 110. The arm portion 110 includes a plurality of parts that are bent and stretched and rotatably assembled. The arm portion 110 can operate the liquid droplet discharge head 300 (and the circulation device 200) mounted on a tip of the arm portion 110 in accordance with a command from a control unit 120. For example, the arm portion 110 can move the liquid droplet discharge head 300 (and the circulation device 200) mounted on the tip of the arm portion 110 in accordance with the command from the control unit 120. This allows the arm portion 110 to change the position of the liquid droplet discharge head 300 (and the circulation device 200). For example, in accordance with the command from the control unit 120, the arm portion 110 can rotate the liquid droplet discharge head 300 (and the circulation device 200) around a predetermined rotation axis (for example, a Y axis or a Z axis). This allows the arm portion 110 to change the posture of the liquid droplet discharge head 300 (and the circulation device 200) such as the orientation and the angle thereof. For example, in accordance with the command from the control unit 120, the arm portion 110 can perform various operations of the liquid droplet discharge head 300 (and the circulation device 200) including swing, tilt, reversal, and the like thereof. The arm portion 110 illustrated in FIG. 1 is not particularly limited to the configuration illustrated in FIG. 1 as long as the arm portion 110 is provided with a degree of freedom with which the liquid droplet discharge head 300 can change the position and posture as necessary.

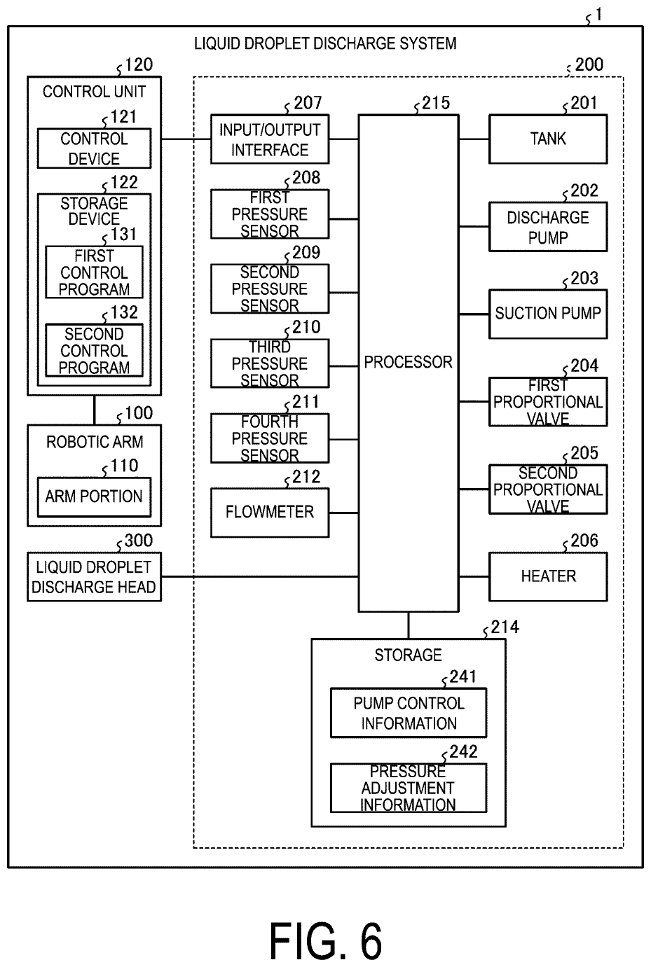

The control unit 120 is built in, for example, the robotic arm 100 (arm portion 110). The control unit 120 may be mounted on an external device independent from the robotic arm 100, and may be communicably connected to the robotic arm 100. The control unit 120 controls the operation of the arm portion 110 by outputting a command to control the operation of the arm portion 110 to an actuator or the like that drives the arm portion 110. The control unit 120 is provided with a control device 121 (see FIG. 6) such as a processor and a storage device 122 (see FIG. 6) such as a memory. The storage device 122 stores, for example, a first control program 131 (see FIG. 6) for controlling an operation of the robotic arm 100, a second control program (see FIG. 6) for controlling an operation related to discharge of the liquid droplet discharge head 300 (hereinafter also referred to as a discharge operation), and the like. The control device 121 controls the operation of the robotic arm 100 (arm portion 110) based on a program, data, and the like stored in the storage device 122.

The robotic arm 100 can change the position in a vertical direction (z axis direction) of the liquid droplet discharge head 300 by moving the circulation device 200 and the liquid droplet discharge head 300 that are mounted on the tip of the arm portion 110 along a predetermined vertical axis (Z axis) by using the arm portion 110. This allows the circulation device 200 and the liquid droplet discharge head 300 to, for example, assume a posture in which, as illustrated in FIG. 1, a discharge surface 300SF for the liquid included in the liquid droplet discharge head 300 faces parallel to a spraying surface 50SF of an object 50. The robotic arm 100 can, for example, cause the arm portion 110 to rotate the circulation device 200 and the liquid droplet discharge head 300 around a predetermined rotation axis, the circulation device 200 and the liquid droplet discharge head 300 being assembled on the tip of the arm portion 110. This allows the circulation device 200 and the liquid droplet discharge head 300 to, for example, switch a position in a longitudinal direction and a position in a lateral direction, or to invert an upper position and a lower position.

The circulation device 200 is installed at a tip portion of the arm portion 110 of the robotic arm 100. The circulation device 200 supplies a liquid to the liquid droplet discharge head 300 while controlling the circulation pressure of the liquid circulating between the circulation device 200 and the liquid droplet discharge head 300. The liquid droplet discharge head 300 is assembled on the circulation device 200 installed at the tip portion of the arm portion 110 of the robotic arm 100. The liquid droplet discharge head 300 functions as a liquid droplet discharge portion that discharges the liquid to the object 50.

The circulation pressure of the liquid to be supplied to the liquid droplet discharge head 300 is affected by the operation of the liquid droplet discharge head 300 performed by the robotic arm 100. When the liquid droplet discharge head 300 is operated by the robotic arm 100 to change the position of the liquid droplet discharge head 300, the circulation pressure (pressure) of the liquid inside the liquid droplet discharge head 300 changes, for example, as illustrated in FIG. 2. FIG. 2 is a diagram for describing changes in the pressure of the liquid inside the liquid droplet discharge head according to the embodiment. When the circulation pressure (pressure) of the liquid inside the liquid droplet discharge head 300 changes, the liquid may not be stably discharged from the liquid droplet discharge head 300. In view of this, the present application proposes a liquid droplet discharge system 1 that can flexibly deal with a change in the position of the liquid droplet discharge head 300 to keep the appropriate circulation pressure of the liquid to be discharged.

### Configuration Example of Liquid Droplet Discharge Head

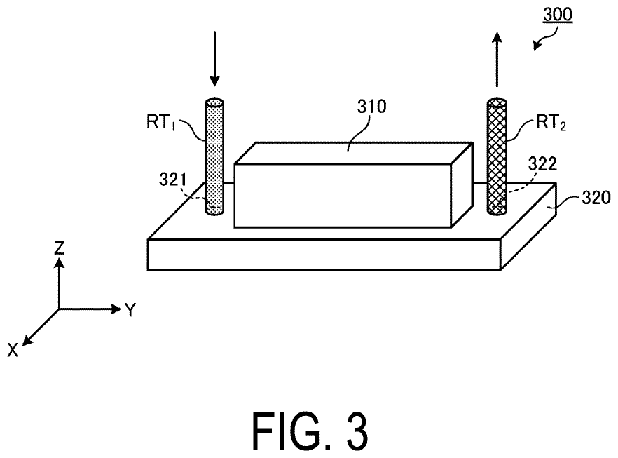

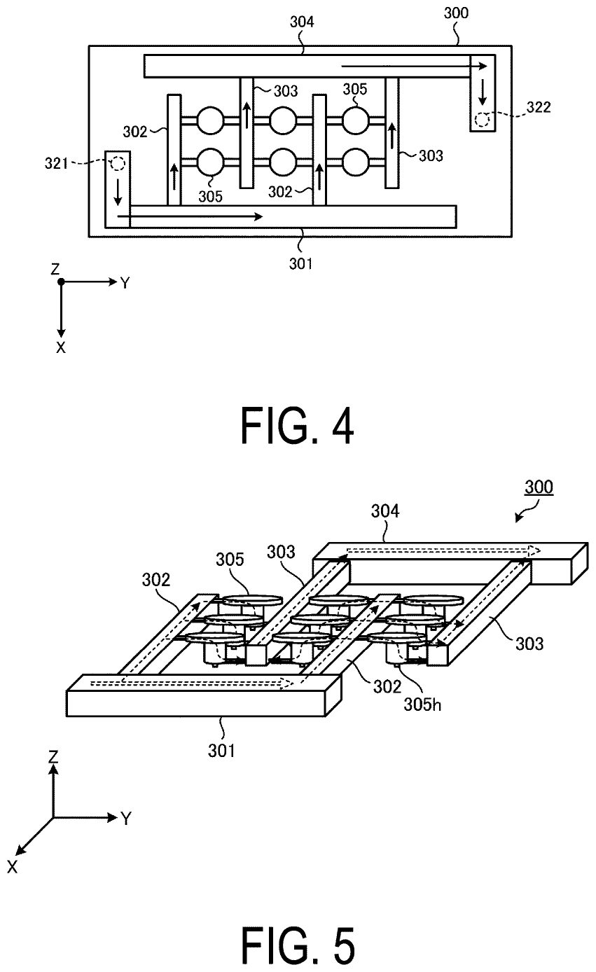

The liquid droplet discharge head 300 according to the embodiment will be described with FIG. 3 to FIG. 5. FIG. 3 is a perspective view schematically illustrating an outer appearance configuration of the liquid droplet discharge head according to the embodiment. FIG. 4 is a plan view of the liquid droplet discharge head according to the embodiment. FIG. 5 is a diagram schematically illustrating channels inside the liquid droplet discharge head according to the embodiment.

As illustrated in FIG. 3, the liquid droplet discharge head 300 includes a housing including a box-shaped member 310 and a substantially plate-shaped member 320. The housing of the liquid droplet discharge head 300 includes a first channel RT₁ installed in the housing to supply a liquid from the circulation device 200 to the inside of the head and a second channel RT₂ installed in the housing to deliver the liquid recovered inside the head back to the circulation device 200. As illustrated in FIG. 3 or FIG. 4, a member 320 of the liquid droplet discharge head 300 includes a supply port 321 through which the liquid is supplied to the inside of the head through the first channel RT₁ and a discharge port 322 through which the liquid is recovered from the inside of the head through the second channel RT₂.

As illustrated in FIG. 4, the liquid droplet discharge head 300 includes a supply reservoir 301, a supply manifold 302, a recovery manifold 303, a recovery reservoir 304, and an element 305.

The supply reservoir 301 has an elongated shape extending in a longitudinal direction (Y axis direction) of the liquid droplet discharge head 300 and connects to the supply manifold 302. The supply reservoir 301 includes a channel inside. As illustrated in FIG. 4 or FIG. 5, the liquid supplied to the supply reservoir 301 through the first channel RT₁ and the supply port 321 and reserved in the channel of the supply reservoir 301 is delivered to the supply manifold 302.

The supply manifold 302 has an elongated shape extending in a lateral direction (X axis direction) of the liquid droplet discharge head 300 to a position before the recovery reservoir 304. The supply manifold 302 internally includes a channel that communicates with the channel included in the supply reservoir 301 and with the element portion 305. As illustrated in FIG. 4 or FIG. 5, the liquid delivered from the supply reservoir 301 to the supply manifold 302 is delivered from the supply manifold 302 to the element 305.

The recovery manifold 303 has an elongated shape extending in the lateral direction (X axis direction) of the liquid droplet discharge head 300 to a position before the supply reservoir 301. The recovery manifold 303 internally includes a channel that communicates with a channel included in the recovery reservoir 304 and with the element portion 305. As illustrated in FIG. 4 or FIG. 5, the liquid having not been discharged from the element 305 (discharge hole 305h) to the outside is delivered to the recovery manifold 303.

The recovery reservoir 304 has an elongated shape extending in the longitudinal direction (Y axis direction) of the liquid droplet discharge head 300 and is connected to the recovery manifold 303. The recovery reservoir 304 includes the channel inside. As illustrated in FIG. 4 or FIG. 5, the liquid delivered from the recovery manifold 303 to the recovery reservoir 304 and reserved in the channel of the recovery reservoir 304 is delivered back to the circulation device 200 through the recovery port 322 and the second channel RT₂.

The element 305 includes a discharge hole 305h. The element 305, for example, sucks the liquid from the supply manifold 302 by negative pressure generated in a pressure chamber not illustrated and discharges the liquid thus sucked from the discharge hole 305h toward the object 50 by positive pressure generated in the pressure chamber not illustrated.

### Example of Functional Configuration of Liquid Droplet Discharge System

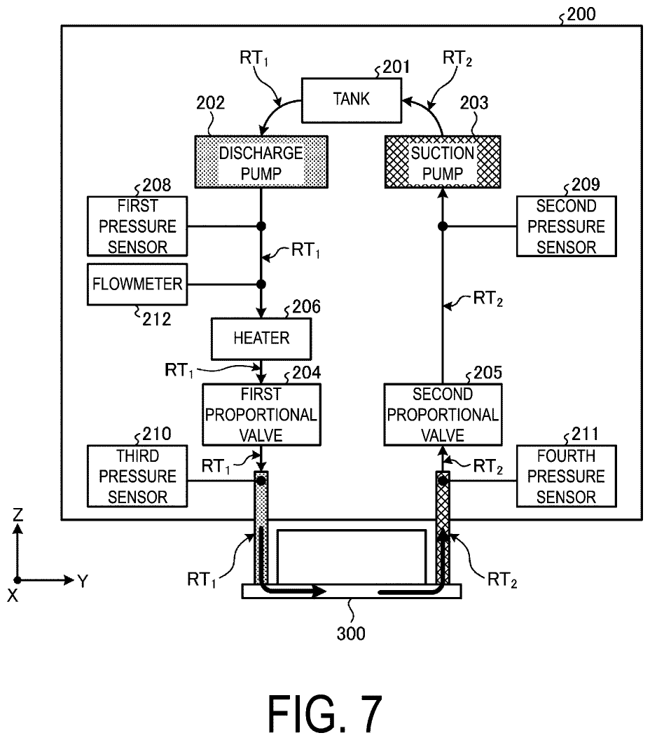

A functional configuration of the liquid droplet discharge system 1 according to the embodiment will be described. FIG. 6 is a block diagram illustrating an example of the functional configuration of the liquid droplet discharge system according to the embodiment. FIG. 7 is a diagram schematically illustrating a circulation mechanism of the circulation device of the liquid droplet discharge system according to the embodiment.

Note that FIG. 6 illustrates an example of the functional configuration of the liquid droplet discharge system 1 and that the embodiment need not be limited to the particular example illustrated in FIG. 6, provided that the configuration can achieve the various functions of the liquid droplet discharge system 1 according to the embodiment. FIG. 6 illustrates, in functional blocks, components provided in the liquid droplet discharge system 1 according to the embodiment and omits a description of other components in general. The constitutional elements of the liquid droplet discharge system 1 illustrated in FIG. 6 are functional concepts and are not limited to the example illustrated in FIG. 6, and are not necessarily physically configured as illustrated. For example, the specific form of distribution and integration of each of the functional blocks is not limited to that illustrated, and all or a portion thereof can be functionally or physically distributed and integrated in any unit, depending on various loads, usage conditions, and the like.

As illustrated in FIG. 6, the liquid droplet discharge system 1 includes the circulation device 200. The circulation device 200 includes a tank 201, a discharge pump 202, a suction pump 203, a first proportional valve 204, a second proportional valve 205, and a heater 206. The circulation device 200 also includes an input/output interface 207, a first pressure sensor 208, a second pressure sensor 209, a third pressure sensor 210, a fourth pressure sensor 211, and a flowmeter 212. The circulation device 200 further includes a storage 214 and a processor 215. The storage 214 and the processor 215 may be mounted independently of the circulation device 200. The liquid droplet discharge system 1 includes the robotic arm 100, the control unit 120, and the liquid droplet discharge head 300.

As illustrated in FIG. 7, the circulation device 200 includes the first channel RT₁ and the second channel RT₂. The first channel RT₁ is a channel communicating the tank 201 and the liquid droplet discharge head 300 with each other to allow the liquid reserved in the tank 201 to flow into the liquid droplet discharge head 300. The second channel RT₂ is a channel communicating the tank 201 and the liquid droplet discharge head 300 with each other to allow the liquid that has flowed into the liquid droplet discharge head 300 to return to the tank 201. The liquid recovered in the liquid droplet discharge head 300 without being discharged from the liquid droplet discharge head 300 to the outside is fed back through the second channel RT₂ to the tank 201. The first channel RT₁ and the second channel RT₂ can be implemented, for example, by a pipe made of a predetermined material that does not interact with constituents of the liquid. As illustrated in FIG. 7, for example, a processor 215 of the circulation device 200 including the components described above controls the circulation pressure of the liquid circulating clockwise between the tank 201 and the liquid droplet discharge head 300.

The tank 201 reserves the liquid supplied to the liquid droplet discharge head 300. The tank 201 functions as a reserve portion for storing the liquid supplied to the liquid droplet discharge head 300.

The discharge pump 202 feeds the liquid reserved in the tank 201 through the first channel RT₁ to the liquid droplet discharge head 300. The discharge pump 202 generates positive pressure for feeding the liquid reserved in the tank 201 to the liquid droplet discharge head 300. The discharge pump 202 can, for example, feed the liquid reserved in the tank 201 to the liquid droplet discharge head 300 at a predetermined constant supply pressure.

The suction pump 203 feeds, through the second channel RT₂, the liquid recovered in the liquid droplet discharge head 300 to the tank 201. The suction pump 203 generates negative pressure used to suck and feed the liquid recovered in the liquid droplet discharge head 300, back to the tank 201. The suction pump 203 can, for example, feed the liquid sucked from the liquid droplet discharge head 300 to the tank 201 at a predetermined constant recovery pressure.

The discharge pump 202 and the suction pump 203 can each be implemented by a rotary pump such as a gear pump or a displacement pump such as a diaphragm pump.

The first proportional valve 204 functions as a first valve portion interposed in the first channel RT₁ between the tank 201 and the liquid droplet discharge head 300 to proportionally control the flow rate of the liquid supplied to the liquid droplet discharge head 300. The first proportional valve 204 can continuously modify the channel cross-sectional area for the liquid between 0 and 100%, and controls the flow rate of the liquid to a desired flow rate. For example, the first proportional valve 204 can reduce the supply pressure when supplying the liquid to the liquid droplet discharge head 300 by reducing the channel cross-sectional area for the liquid. On the other hand, the first proportional valve 204 can increase the supply pressure when supplying the liquid to the liquid droplet discharge head 300 by increasing the channel cross-sectional area for the liquid.

The second proportional valve 205 functions as a second valve portion interposed in the second channel RT₂ between the tank 201 and the liquid droplet discharge head 300 to proportionally control the flow rate of the liquid fed from the liquid droplet discharge head 300 to the tank 201. The second proportional valve 205, as with the first proportional valve 204, can continuously modify the channel cross-sectional area for the liquid between 0 and 100%, and controls the flow rate of the liquid to a desired flow rate. For example, the second proportional valve 205 can reduce the recovery pressure when recovering the liquid from the liquid droplet discharge head 300 by reducing the channel cross-sectional area for the liquid. On the other hand, the second proportional valve 205 can increase the recovery pressure when recovering the liquid from the liquid droplet discharge head 300 by increasing the channel cross-sectional area for the liquid.

The first proportional valve 204 and the second proportional valve 205 can be implemented by a proportional selector valve of an electromagnetic type or a proportional selector valve of a pneumatic type.

The heater 206 is provided in the first channel RT₁ or adjacent to the first channel RT₁, and heats the liquid flowing through the first channel RT₁.

The input/output interface 207 exchanges various types of information with the control unit 120 of the robotic arm 100. The input/output interface 207 can, for example, receive a signal indicating the start of the discharge of the liquid from the control unit 120 and a signal indicating the end of the discharge of the liquid. Under the control of the processor 215, the input/output interface 207 can acquire information about the operation of the liquid droplet discharge head 300 from the first control program 131 stored in the storage device 122 of the control unit 120. As the information related to the operation of the liquid droplet discharge head 300, for example, numerical values related to the movement of the liquid droplet discharge head 300 are acquired. Examples of the numerical values related to the movement of the liquid droplet discharge head 300 include the position of the liquid droplet discharge head 300 in the vertical direction, the vertical acceleration acting on the liquid droplet discharge head 300, and the horizontal acceleration acting on the liquid droplet discharge head 300. The information regarding the operation of the liquid droplet discharge head 300 may be, for example, numerical values regarding various operations of the liquid droplet discharge head 300 including swing, tilt, reversal, and the like thereof. The input/output interface 207 functions as an acquiring unit that acquires information related to the operation of the liquid droplet discharge head 300 from the first control program 131 controlling the operation of the robotic arm 100 that performs the operation of the liquid droplet discharge head 300.

The first pressure sensor 208 measures the pressure of the liquid fed by the discharge pump 202 from the tank 201 to the liquid droplet discharge head 300. The first pressure sensor 208 measures the pressure downstream of the discharge pump 202 in a circulation direction of the liquid in the circulation device 200. The first pressure sensor 208 sends a measurement result to the processor 215.

The second pressure sensor 209 measures the pressure of the liquid that is sucked from the liquid droplet discharge head 300 by the suction pump 203 and fed to the tank 201. The second pressure sensor 209 measures the pressure upstream of the suction pump 203 in the circulation direction of the liquid in the circulation device 200. The second pressure sensor 209 sends a measurement result to the processor 215.

The third pressure sensor 210 functions as a first pressure measuring portion that measures, through the first channel RT₁, the pressure of the liquid flowing between the first proportional valve 204 and the liquid droplet discharge head 300 as the supply pressure. The third pressure sensor 210 measures the pressure of the liquid immediately before the liquid flows into the liquid droplet discharge head 300 after passing through the first proportional valve 204. That is, the third pressure sensor 210 measures the pressure downstream of the first proportional valve 204 in the circulation direction of the liquid in the circulation device 200 as a supply pressure. The third pressure sensor 210 sends a measurement result to the processor 215.

The fourth pressure sensor 211 functions as a second pressure measuring portion that measures, through the second channel RT₂, the pressure of the liquid flowing between the second proportional valve 205 and the liquid droplet discharge head 300 as the recovery pressure. The fourth pressure sensor 211 measures the pressure of the liquid immediately after the liquid is fed from the liquid droplet discharge head 300 toward the tank 201 and before the liquid passes through the second proportional valve 205. That is, the fourth pressure sensor 211 measures the pressure upstream of the second proportional valve 205 in the circulation direction of the liquid in the circulation device 200 as the recovery pressure. The fourth pressure sensor 211 sends a measurement result to the processor 215.

The flowmeter 212 measures the flow rate of the liquid fed to the liquid droplet discharge head 300. The flowmeter 212 sends a measurement result to the processor 215.

The storage 214 stores programs and data necessary for various processes of the liquid droplet discharge system 1 (here, the circulation device 200). The storage 214 stores, for example, pump control information 241 and pressure adjustment information 242.

The pump control information 241 is set in advance and used for pump control. The data for pump control includes, for example, a target value of pressure (positive pressure) applied to the liquid that the discharge pump 202 feeds and a target value of pressure (negative pressure) applied to the liquid that the suction pump 203 sucks. When considering the discharge of the liquid from the liquid droplet discharge head 300, the target value of the positive pressure of the discharge pump 202 is preset to, for example, a value approximately 1.2 to 3 times higher than the pressure at which the liquid is supplied to the liquid droplet discharge head 300. In contrast, the target value for the negative pressure of the suction pump 203 is preset to a value approximately 1.2 to 3 times lower than the pressure at which the liquid is supplied to the liquid droplet discharge head 300.

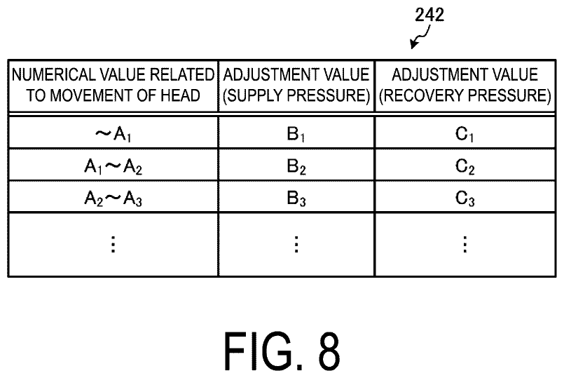

The pressure adjustment information 242 is data in which the adjustment value for the supply pressure and the adjustment value for the recovery pressure for suppressing a change in the pressure of the liquid inside the liquid droplet discharge head 300 are each associated with the numerical value related to the movement of the liquid droplet discharge head 300 on a per magnitude basis. FIG. 8 is a diagram illustrating an overview of the pressure adjustment information according to the embodiment.

As illustrated in FIG. 8, the pressure adjustment information 242 includes the item “numerical value related to head movement”, the item “adjustment value (supply pressure)”, and the item “adjustment value (recovery pressure)”, and these items are associated with one another. The item “numerical value related to head movement” stores, as a numerical value related to the movement of the liquid droplet discharge head 300, the position of the liquid droplet discharge head 300 in the vertical direction, the vertical acceleration acting on the liquid droplet discharge head 300, or the horizontal acceleration acting on the liquid droplet discharge head 300. The item “adjustment value (supply pressure)” stores a target value used when the supply pressure is adjusted (hereinafter also referred to as “adjustment value” as appropriate). The item “adjustment value (recovery pressure)” stores a target value used when the recovery pressure is adjusted (hereinafter also referred to as “adjustment value” as appropriate).

A change in the position in the vertical direction and the like of the liquid droplet discharge head 300 may cause a hydraulic head pressure to act on the liquid circulating inside the head, changing the circulation pressure of the liquid circulating inside the head, and making the discharge of the liquid from the liquid droplet discharge head 300 unstable. An experiment, a simulation, or the like is performed to obtain in advance the relationship between a change in the position or the like of the liquid droplet discharge head 300 in the vertical direction and the adjustment value for the supply pressure and the adjustment value for the recovery pressure which are used to keep the pressure of the liquid inside the head constant. The supply pressure can be obtained from the measurement result obtained by the third pressure sensor 210. The recovery pressure can be obtained from the measurement result obtained by the fourth pressure sensor 211. The adjustment value for the supply pressure and the adjustment value for the recovery pressure are stored in the pressure adjustment information 242 in association with the numerical value indicating the position of the liquid droplet discharge head 300 in the vertical direction or the like on a per magnitude basis.

Note that the pressure adjustment information 242 may be prepared in accordance with the type of the numerical value related to the movement of the liquid droplet discharge head 300. That is, the pressure adjustment information 242 may be individually prepared for each of the position of the liquid droplet discharge head 300 in the vertical direction, the vertical acceleration acting on the liquid droplet discharge head 300, and the horizontal acceleration acting on the liquid droplet discharge head 300.

The processor 215 executes various processing operations in the liquid droplet discharge system 1 (here, the circulation device 200) based on programs, data, and the like that are stored in the storage 214. The processor 215 implements various functions for controlling the components of the liquid droplet discharge system 1 (here, the circulation device 200) by reading out and executing the computer program stored in the storage 214.

### Control of Pump

The processor 215 makes an adjustment to keep constant the positive pressure applied to the liquid that the discharge pump 202 feeds based on the measurement result of the first pressure sensor 208 and the measurement result of the third pressure sensor 210. For example, the processor 215 adjusts the positive pressure of the discharge pump 202 in such a manner that the pressure of the liquid obtained from the measurement result of the first pressure sensor 208 remains approximately 1.2 to 3 times larger than the pressure of the liquid obtained from the measurement result of the third pressure sensor 210.

The processor 215 makes an adjustment to keep constant the negative pressure applied to the liquid that the suction pump 203 sucks based on the measurement results of the second pressure sensor 209 and the fourth pressure sensor 211. For example, the processor 215 adjusts the negative pressure of the suction pump 203 in such a manner that the pressure of the liquid obtained from the measurement result of the second pressure sensor 209 remains approximately 1.2 to 3 times lower than the pressure of the liquid obtained from the measurement result of the fourth pressure sensor 211.

The processor 215 circulates the liquid between the tank 201 and the liquid droplet discharge head 300 by adjusting and keeping constant the differential pressure between the positive pressure that the discharge pump 202 applies to the liquid and the negative pressure that the suction pump 203 applies to the liquid.

### Control of Proportional Valve

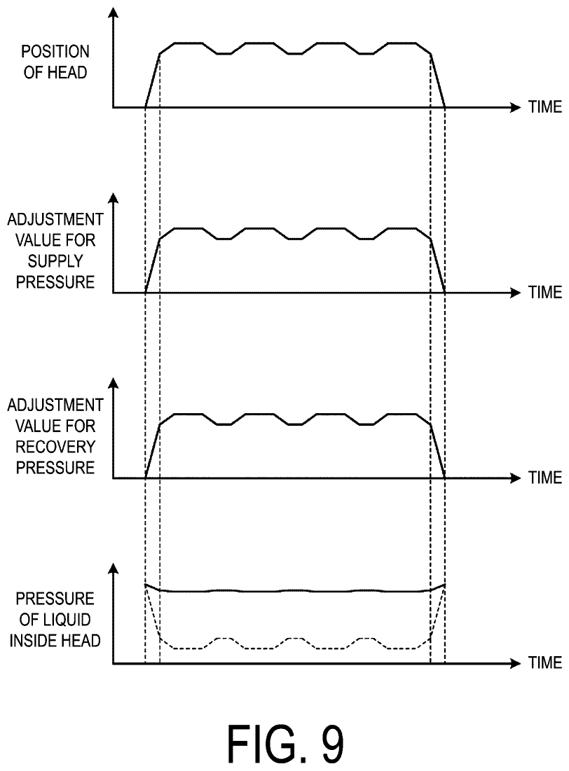

The processor 215 controls the first proportional valve 204 and the second proportional valve 205 based on the numerical value obtained by the input/output interface 207 to adjust the supply pressure and the recovery pressure. A method of controlling the first proportional valve 204 and the second proportional valve 205 will be described below using FIG. 9 to FIG. 11.

FIG. 9 is a diagram for describing a method of controlling the first proportional valve and the second proportional valve based on the position of the liquid droplet discharge head according to the embodiment. The first row from the top of FIG. 9 schematically illustrates an example of the relationship between time and the position of the liquid droplet discharge head 300 in the vertical direction. The second and third rows from the top of FIG. 9 schematically illustrate an example of the relationship between time and the adjustment value for the supply pressure and the adjustment value for the recovery pressure. The fourth row from the top of FIG. 9 schematically illustrates an example of the relationship between time and the circulation pressure of the liquid inside the liquid droplet discharge head 300. Here, the posture of the liquid droplet discharge head 300 is assumed to be a posture in which the discharge surface 300SF for the liquid is directed vertically downward (see FIG. 1).

With reference to FIG. 9, control performed in a case where the liquid droplet discharge head 300 moves at a constant speed in the vertical direction will be described.

As illustrated in FIG. 9, when the liquid droplet discharge head 300 moves to change the position of the liquid droplet discharge head 300, the circulation pressure of the liquid inside the liquid droplet discharge head 300 is predicted to change due to the hydraulic head pressure acting on the liquid circulating inside the head. In FIG. 9, a graph of a broken line indicates changes in the circulation pressure of the liquid inside the liquid droplet discharge head 300 due to the effect of the hydraulic head pressure. When the circulation pressure of the liquid in the liquid droplet discharge head 300 changes, the liquid may not be stably discharged from the liquid droplet discharge head 300.

The processor 215 controls the input/output interface 207 to acquire the position of the liquid droplet discharge head 300 in the vertical direction. Specifically, the input/output interface 207 acquires the position of the liquid droplet discharge head 300 in the vertical direction from the first control program 131 as a numerical value related to the movement of the liquid droplet discharge head 300.

The processor 215 adjusts the supply pressure and the recovery pressure to keep constant the circulation pressure (pressure) of the liquid inside the liquid droplet discharge head 300, the circulation pressure of the liquid changing depending on the acquired position of the liquid droplet discharge head 300. Here, “the circulation pressure (pressure) of the liquid becomes constant” is a concept including not only a case where the pressure of the liquid becomes strictly constant but also a case where the pressure of the liquid approaches a constant value. In other words, the processor 215 may adjust the supply pressure and the recovery pressure in such a manner that the circulation pressure (pressure) of the liquid inside the liquid droplet discharge head 300 approaches a constant value. For example, the processor 215 may adjust the supply pressure and the recovery pressure to reduce the circulation pressure when the pressure in the head increases, and may adjust the supply pressure and the recovery pressure to increase the circulation pressure when the pressure in the head decreases.

In the example illustrated in FIG. 9, the circulation pressure (pressure) of the liquid inside the liquid droplet discharge head 300 is predicted to decrease with increasing height of the position of the liquid droplet discharge head 300 due to the effect of the hydraulic head pressure. In order to keep the circulation pressure (pressure) of the liquid inside the liquid droplet discharge head 300 constant, both the supply pressure and the recovery pressure need to be increased to cancel the effect of the hydraulic head pressure. The processor 215 refers to the pressure adjustment information 242 to determine the adjustment value for the supply pressure and the adjustment value for the recovery pressure corresponding to the acquired position of the liquid droplet discharge head 300. The adjustment value for the supply pressure and the adjustment value for the recovery pressure increase consistently with the height of the position of the liquid droplet discharge head 300. While referring to the measurement result of the third pressure sensor 210, the processor 215 increases the flow rate of a fluid passing through the first proportional valve 204 by widening the channel cross-sectional area of the first proportional valve 204 in order to increase the supply pressure to a target pressure based on the determined adjustment value. On the other hand, while referring to the measurement result of the fourth pressure sensor 211, the processor 215, increases the flow rate of the fluid passing through the second proportional valve 205 by widening the channel cross-sectional area of the second proportional valve 205 in order to increase the recovery pressure to a target pressure based on the determined adjustment value.

In the example illustrated in FIG. 9, the circulation pressure (pressure) of the liquid inside the liquid droplet discharge head 300 is predicted to increase with decreasing height of the position of the liquid droplet discharge head 300 due to the effect of the hydraulic head pressure. In order to keep the circulation pressure (pressure) of the liquid inside the liquid droplet discharge head 300 constant, both the supply pressure and the recovery pressure need to be reduced to cancel the effect of the hydraulic head pressure. The processor 215 refers to the pressure adjustment information 242 to determine the adjustment values for the supply pressure and the recovery pressure corresponding to the acquired position of the liquid droplet ejection head 300. The adjustment value for the supply pressure and the adjustment value for the recovery pressure decrease consistently with the height of the position of the liquid droplet discharge head 300. While referring to the measurement result of the third pressure sensor 210, the processor 215 reduces the flow rate of the fluid passing through the first proportional valve 204 by narrowing the channel cross-sectional area of the first proportional valve 204 in order to reduce the supply pressure to a target pressure based on the determined adjustment value. On the other hand, while referring to the measurement result of the fourth pressure sensor 211, the processor 215 reduces the flow rate of the fluid passing through the second proportional valve 205 by narrowing the channel cross-sectional area of the second proportional valve 205 in order to reduce the recovery pressure to a target pressure based on the determined adjustment value.

In this way, the processor 215 can increase or reduce the flow rate of the fluid passing through the first proportional valve 204 and the second proportional valve 205 in accordance with the position of the liquid droplet discharge head 300 in the vertical direction. As a result, the processor 215 can keep the circulation pressure (pressure) of the liquid inside the liquid droplet discharge head 300 constant.

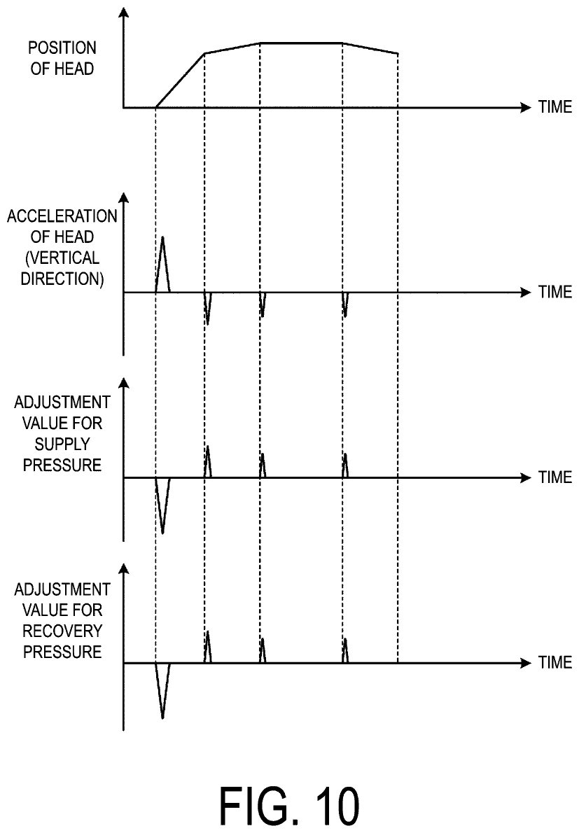

FIG. 10 is a diagram for describing the method of controlling the first proportional valve and the second proportional valve based on the vertical acceleration acting on the liquid droplet discharge head according to the embodiment. The first row from the top of FIG. 10 schematically illustrates an example of the relationship between time and the position of the liquid droplet discharge head 300 in the vertical direction. The second row from the top of FIG. 10 schematically illustrates an example of the relationship between time and the vertical acceleration acting on the liquid droplet discharge head 300. The third and fourth rows from the top of FIG. 10 schematically illustrate an example of the relationship between time and the adjustment value for the supply pressure and the adjustment value for the recovery pressure. Here, the posture of the liquid droplet discharge head 300 is assumed to be a posture in which the discharge surface 300SF for the liquid is directed vertically downward (see FIG. 1).

Control performed when the liquid droplet discharge head 300 moves while accelerating and decelerating in the vertical direction will be described with reference to FIG. 10.

As illustrated in FIG. 10, the circulation pressure (pressure) of the liquid inside the liquid droplet discharge head 300 is predicted to change when the liquid droplet discharge head 300 moves to change the acceleration of the liquid droplet discharge head 300 due to the hydraulic head pressure acting on the liquid circulating inside the head. When the circulation pressure (pressure) of the liquid inside the liquid droplet discharge head 300 changes, the liquid may not be stably discharged from the liquid droplet discharge head 300.

The processor 215 controls the input/output interface 207 to acquire the vertical acceleration acting on the liquid droplet discharge head 300. Specifically, the input/output interface 207 acquires the vertical acceleration acting on the liquid droplet discharge head 300, from the first control program 131 as a numerical value related to the movement of the liquid droplet discharge head 300.

The processor 215 adjusts the supply pressure and the recovery pressure to keep constant the circulation pressure (pressure) of the liquid inside the liquid droplet discharge head 300, the circulation pressure of the liquid changing according to the acquired vertical acceleration.

In the example illustrated in FIG. 10, the circulation pressure (pressure) of the liquid inside the liquid droplet discharge head 300 is predicted to increase as the acceleration of the liquid droplet discharge head 300 in the vertically upward direction increases due to the effect of the hydraulic head pressure. In order to keep the circulation pressure (pressure) of the liquid inside the liquid droplet discharge head 300 constant, both the supply pressure and the recovery pressure need to be reduced to cancel the effect of the hydraulic head pressure. The processor 215 determines the adjustment value for the supply pressure and the adjustment value for the recovery pressure corresponding to the acquired vertical acceleration with reference to the pressure adjustment information 242. The adjustment value for the supply pressure and the adjustment value for the recovery pressure decrease as the vertically upward acceleration of the liquid droplet discharge head 300 increases. While referring to the measurement result of the third pressure sensor 210, the processor 215 reduces the flow rate of the fluid passing through the first proportional valve 204 by narrowing the channel cross-sectional area of the first proportional valve 204 in order to reduce the supply pressure to a target pressure based on the determined adjustment value. On the other hand, while referring to the measurement result of the fourth pressure sensor 211, the processor 215 reduces the flow rate of the fluid passing through the second proportional valve 205 by narrowing the channel cross-sectional area of the second proportional valve 205 in order to reduce the recovery pressure to a target pressure based on the determined adjustment value.

In the example illustrated in FIG. 10, the circulation pressure (pressure) of the liquid inside the liquid droplet discharge head 300 is predicted to decrease as the acceleration of the liquid droplet discharge head 300 in the vertically upward direction decreases due to the effect of the hydraulic head pressure. In order to keep the circulation pressure (pressure) of the liquid inside the liquid droplet discharge head 300 constant, both the supply pressure and the recovery pressure need to be increased to cancel the effect of the hydraulic head pressure. The processor 215 refers to the pressure adjustment information 242 to determine the adjustment value for the supply pressure and the adjustment value for the recovery pressure corresponding to the acquired position of the liquid droplet discharge head 300. The adjustment value for each of the supply pressure and the recovery pressure increases as the vertically upward acceleration of the liquid droplet discharge head 300 decreases. While referring to the measurement result of the third pressure sensor 210, the processor 215 increases the flow rate of a fluid passing through the first proportional valve 204 by widening the channel cross-sectional area of the first proportional valve 204 in order to increase the supply pressure to a target pressure based on the determined adjustment value. On the other hand, while referring to the measurement result of the fourth pressure sensor 211, the processor 215 increases the flow rate of the fluid passing through the second proportional valve 205 by widening the channel cross-sectional area of the second proportional valve 205 in order to increase the recovery pressure to a target pressure based on the determined adjustment value.

In this way, the processor 215 can increase or decrease the flow rate of the fluid passing through the first proportional valve 204 and the second proportional valve 205 in accordance with the vertical acceleration acting on the droplet discharge head 300. As a result, the processor 215 can keep the circulation pressure (pressure) of the liquid inside the liquid droplet discharge head 300 constant.

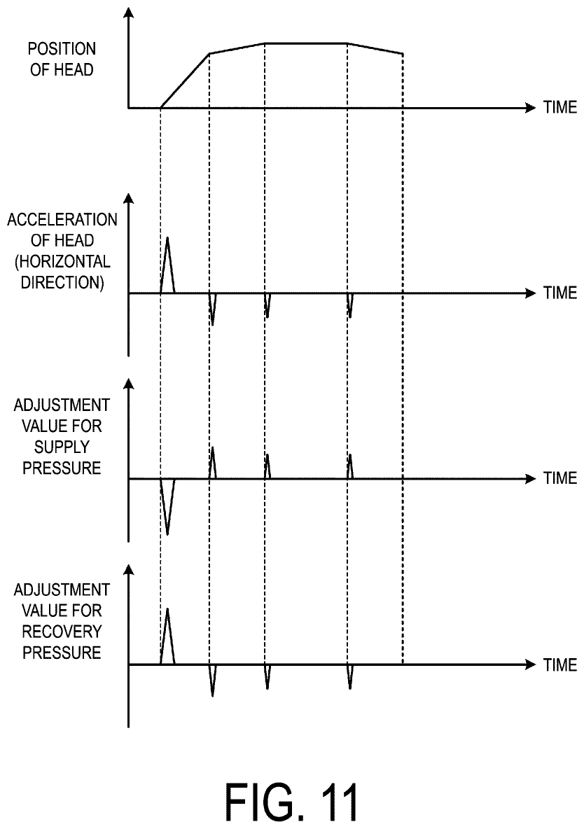

FIG. 11 is a diagram for describing the method of controlling the first proportional valve and the second proportional valve based on the acceleration acting on the liquid droplet horizontal discharge head according to the embodiment. The first row from the top of FIG. 11 schematically illustrates an example of the relationship between time and the position of the liquid droplet discharge head 300 in the horizontal direction. The second row from the top of FIG. 10 schematically illustrates an example of the relationship between time and the horizontal acceleration acting on the liquid droplet discharge head 300. The third and fourth rows from the top of FIG. 10 schematically illustrate an example of the relationship between time and the adjustment value for the supply pressure and the adjustment value for the recovery pressure. Here, the posture of the liquid droplet discharge head 300 is assumed to be a posture in which the discharge surface 300SF for the liquid is directed vertically downward (see FIG. 1).

With reference to FIG. 11, control performed in a case where the liquid droplet discharge head 300 moves while accelerating and decelerating in the horizontal direction will be described. Note that, in FIG. 11, the horizontal acceleration acting on the liquid droplet discharge head 300 is the acceleration in the direction from the downstream side to the upstream side of the liquid flowing inside the liquid droplet discharge head 300. Here, the downstream side is a recovery side (that is, a recovery port 322 side) on which the liquid is recovered from the liquid droplet discharge head 300, and the upstream side is a supply side (that is, a supply port 321 side) on which the liquid is supplied to the liquid droplet discharge head 300.

As illustrated in FIG. 11, the circulation pressure (pressure) of the liquid inside the liquid droplet discharge head 300 is predicted to change when the liquid droplet discharge head 300 moves to change the acceleration of the liquid droplet discharge head 300, due to the hydraulic head pressure acting on the liquid circulating inside the head. When the circulation pressure (pressure) of the liquid inside the liquid droplet discharge head 300 changes, the liquid may not be stably discharged from the liquid droplet discharge head 300.

The processor 215 controls the input/output interface 207 to acquire the horizontal acceleration acting on the liquid droplet discharge head 300. Specifically, the input/output interface 207 acquires the horizontal acceleration acting on the liquid droplet discharge head 300, from the first control program 131 as a numerical value related to the movement of the liquid droplet discharge head 300.

The processor 215 adjusts the supply pressure and the recovery pressure to keep constant the circulation pressure (pressure) of the liquid inside the liquid droplet discharge head 300, the circulation pressure of the liquid changing according to the acquired horizontal acceleration.

In the example illustrated in FIG. 11, the upstream pressure of the liquid flowing inside the liquid droplet discharge head 300 is predicted to become higher than the downstream pressure with progression of the acceleration in the direction from the downstream side toward the upstream side of the liquid flowing inside the liquid droplet discharge head 300 due to the effect of the hydraulic head pressure. In order to keep the circulation pressure (pressure) of the liquid inside the liquid droplet discharge head 300 constant, it is necessary to reduce the supply pressure while increasing the recovery pressure to cancel the effect of the hydraulic head pressure. The processor 215 refers to the pressure adjustment information 242 to determine the adjustment value for the supply pressure and the adjustment value for the recovery pressure corresponding to the acquired horizontal acceleration. The adjustment value for the supply pressure decreases with increasing acceleration in the direction from the downstream side toward the upstream side of the liquid flowing inside the liquid droplet discharge head 300. On the other hand, the adjustment value for the recovery pressure increases consistently with the acceleration in the direction from the downstream side toward the upstream side of the liquid flowing inside the liquid droplet discharge head 300. While referring to the measurement result of the third pressure sensor 210, the processor 215 reduces the flow rate of the fluid passing through the first proportional valve 204 by narrowing the channel cross-sectional area of the first proportional valve 204 in order to reduce the supply pressure to a target pressure based on the determined adjustment value. On the other hand, while referring to the measurement result of the fourth pressure sensor 211, the processor 215 increases the flow rate of the fluid passing through the second proportional valve 205 by widening the channel cross-sectional area of the second proportional valve 205 in order to increase the recovery pressure to a target pressure based on the determined adjustment value.

In the example illustrated in FIG. 11, the upstream pressure of the liquid flowing inside the liquid droplet discharge head 300 is predicted to become lower than the downstream pressure with decreasing acceleration in the direction from the downstream side toward the upstream side of the liquid flowing inside the liquid droplet discharge head 300 due to the effect of the hydraulic head pressure. In order to keep the circulation pressure (pressure) of the liquid inside the liquid droplet discharge head 300 constant, it is necessary to increase the supply pressure while reducing the recovery pressure to cancel the effect of the hydraulic head pressure. The processor 215 refers to the pressure adjustment information 242 to determine the adjustment value for the supply pressure and the adjustment value for the recovery pressure corresponding to the acquired horizontal acceleration. The adjustment value for the supply pressure increases with decreasing acceleration in the direction from the downstream side toward the upstream side of the liquid flowing inside the liquid droplet discharge head 300. On the other hand, the adjustment value for the recovery pressure decreases consistently with the acceleration in the direction from the downstream side toward the upstream side of the liquid flowing inside the liquid droplet discharge head 300. While referring to the measurement result of the third pressure sensor 210, the processor 215 increases the flow rate of a fluid passing through the first proportional valve 204 by widening the channel cross-sectional area of the first proportional valve 204 in order to increase the supply pressure to a target pressure based on the determined adjustment value. On the other hand, while referring to the measurement result of the fourth pressure sensor 211, the processor 215 reduces the flow rate of the fluid passing through the second proportional valve 205 by narrowing the channel cross-sectional area of the second proportional valve 205 in order to reduce the recovery pressure to a target pressure based on the determined adjustment value.

In this way, the processor 215 can increase or reduce the flow rate of the fluid passing through the first proportional valve 204 and the second proportional valve 205 in accordance with the horizontal acceleration acting on the droplet discharge head 300. As a result, the processor 215 can keep the circulation pressure (pressure) of the liquid inside the liquid droplet discharge head 300 constant.

### Example of Processing Procedure of Liquid Droplet Discharge System

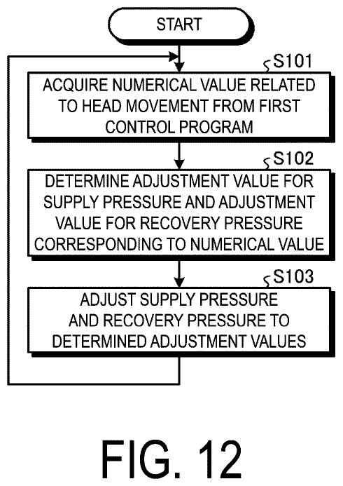

An example of a processing procedure of the liquid droplet discharge system 1 according to the embodiment will be described using FIG. 12. FIG. 12 is a flowchart illustrating an example of the processing procedure of the liquid droplet discharge system according to the embodiment. The processing illustrated in FIG. 12 is executed by the processor 215. The processing illustrated in FIG. 12 is repeatedly executed during the operation of the liquid droplet discharge system 1.

As illustrated in FIG. 12, the processor 215 controls the input/output interface 207 to acquire, from the first control program 131, the numerical value related to the movement of the liquid droplet discharge head 300 (step S101). That is, the input/output interface 207 acquires, as the numerical value, at least one selected from the group consisting of the position of the liquid droplet discharge head 300 in the vertical direction, the vertical acceleration acting on the liquid droplet discharge head 300, and the horizontal acceleration acting on the liquid droplet discharge head 300.

The processor 215 refers to the pressure adjustment information 242 and determines the adjustment values for the supply pressure and recovery pressure corresponding to the acquired numerical values (step S102).

Then, the processor 215 adjusts, to the determined adjustment values, the supply pressure and the recovery pressure of the liquid circulating between the tank 201 and the liquid droplet discharge head 300 (step S103), and returns to the processing procedure of the step S101.

### Other Embodiments

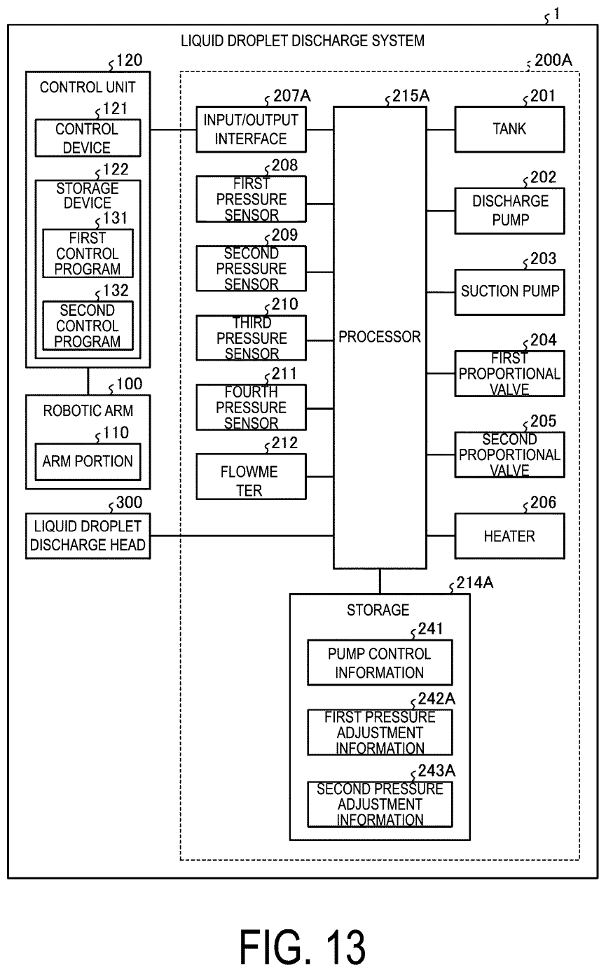

The liquid droplet discharge system 1 according to another embodiment will be described using FIG. 13 to FIG. 15. FIG. 13 is a diagram illustrating an example of a functional configuration of the liquid droplet discharge system according to such another embodiment. Since the circulation mechanism of a circulation device 200A in the liquid droplet discharge system 1 according to such another embodiment is the same as the circulation mechanism of the circulation device 200 in the liquid droplet discharge system 1 according to the embodiment illustrated in FIG. 7, description thereof will be omitted.

As illustrated in FIG. 13, the liquid droplet discharge system 1 according to such another embodiment includes the circulation device 200A. The circulation device 200A includes an input/output interface 207A instead of the input/output interface 207 illustrated in FIG. 6. The circulation device 200A includes a storage 214A and a processor 215A instead of the storage 214 and the processor 215 illustrated in FIG. 6.

As with the input/output interface 207 illustrated in FIG. 6, the input/output interface 207A exchanges various types of information with the control unit 120 of the robotic arm 100. As with the input/output interface 207, under the control of the processor 215, the input/output interface 207A can acquire the numerical value related to the movement of the liquid droplet discharge head 300 from the first control program 131 stored in the storage device 122 of the control unit 120. Under the control of the processor 215A, the input/output interface 207A can further acquire a printing rate of the liquid droplet discharge head 300 from the second control program 132 stored in the storage device 122 of the control unit 120. The “printing rate” refers to, for example, the ratio (S1/S2) of the integrated area S1 of the liquid discharged onto the object 50 to the area S2 of the spraying surface 50SF of the object 50, and may be calculated from image data to be printed. The input/output interface 207A functions as an acquiring unit that acquires the printing rate of the liquid droplet discharge head 300 from the second control program 132 that controls the operation related to the discharge of the liquid droplet discharge head 300.

The storage 214A stores programs and data necessary for various processing operations of the liquid droplet discharge system 1 (here, the circulation device 200A). The storage 214A stores, for example, the pump control information 241, first pressure adjustment information 242A, and second pressure adjustment information 243A. The pump control information 241 has a data structure being the same as or similar to that of the pump control information 241 illustrated in FIG. 6. The first pressure adjustment information 242A has a data structure being the same as or similar to that of the pressure adjustment information 242 illustrated in FIG. 6.

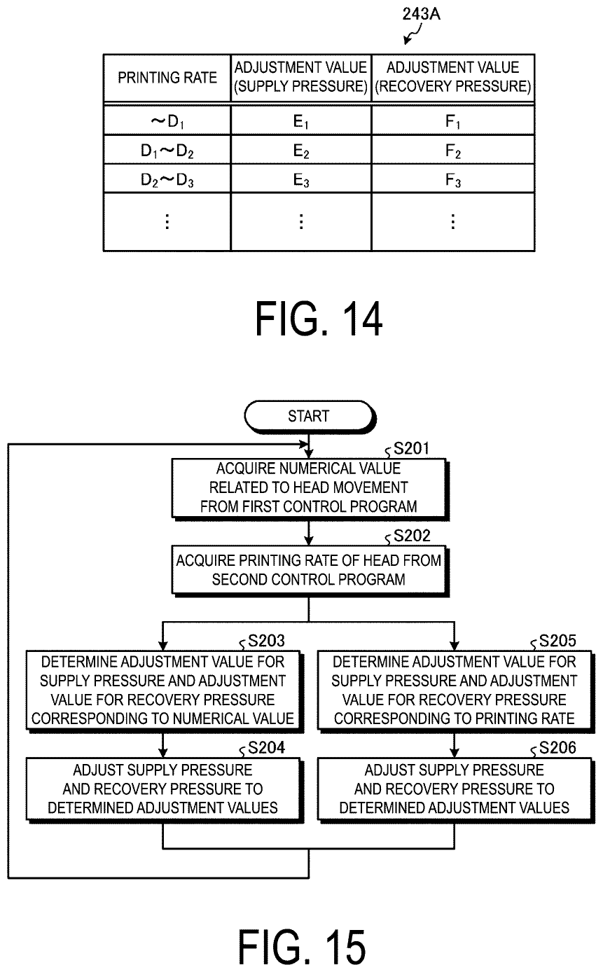

In the second pressure adjustment information 243A, the adjustment value for the supply pressure and the adjustment value for the recovery pressure for suppressing changes in the pressures of the liquid inside the liquid droplet discharge head 300 are associated with the printing rate of the liquid droplet discharge heads 300 on a per magnitude basis. FIG. 14 is a diagram illustrating an overview of the second pressure adjustment information according to such another embodiment.

As illustrated in FIG. 14, the second pressure adjustment information 243A includes the item “printing rate”, the item “adjustment value (supply pressure)”, and the item “adjustment value (recovery pressure)”, and these items are associated with one another. The item “printing rate” stores the printing rate of the liquid droplet discharge head 300. The item “adjustment value (supply pressure)” stores a target value used when the supply pressure is adjusted (hereinafter also referred to as “adjustment value” as appropriate). The item “adjustment value (recovery pressure)” stores a target value used when the recovery pressure is adjusted (hereinafter also referred to as “adjustment value” as appropriate).

A change in the printing rate of the liquid droplet discharge head 300 may change the circulation pressure (pressure) of the liquid circulating inside the head, making discharge from the liquid droplet discharge head 300 unstable. An experiment, a simulation, or the like is performed to obtain in advance the relationship between a change in the printing rate of the liquid droplet discharge head 300 and the adjustment value for the supply pressure and the adjustment value for the recovery pressure which are used to keep the pressure of the liquid inside the head constant. The supply pressure can be obtained from the measurement result obtained by the third pressure sensor 210. The recovery pressure can be obtained from the measurement result obtained by the fourth pressure sensor 211. Then, the adjustment value for the supply pressure and the adjustment value for the recovery pressure are stored in the second pressure adjustment information 243A in association with the printing rate of the liquid droplet discharge head 300 on a per magnitude basis.

The processor 215A controls the first proportional valve 204 and the second proportional valve 205 based on the numerical value acquired by the input/output interface 207A to adjust the supply pressure and the recovery pressure. In parallel with the adjustment of the supply pressure and the recovery pressure based on the numerical value, the processor 215A controls the first proportional valve 204 and the second proportional valve 205 based on the printing rate acquired by the input/output interface 207A to adjust the supply pressure and the recovery pressure. In other words, the processor 215A performs the adjustment of the supply pressure and the recovery pressure based on the numerical value related to the operation of the liquid droplet discharge head 300 in parallel with the adjustment of the supply pressure and the recovery pressure based on the printing rate of the liquid droplet discharge head 300. Hereinafter, the method of controlling the first proportional valve 204 and the second proportional valve 205 based on the printing rate of the liquid droplet discharge head 300 will be described.

When the liquid droplet discharge head 300 moves to change the position of the liquid droplet discharge head 300, the circulation pressure (pressure) of the liquid inside the liquid droplet discharge head 300 is predicted to change due to the hydraulic head pressure acting on the liquid circulating inside the head. When the printing rate of the liquid droplet discharge head 300 changes, the circulation pressure (pressure) of the liquid inside the liquid droplet discharge head 300 is predicted to change. When the circulation pressure (pressure) of the liquid inside the liquid droplet discharge head 300 changes, the liquid may not be stably discharged from the liquid droplet discharge head 300.

The processor 215A controls the input/output interface 207 to acquire the numerical value related to the movement of the liquid droplet discharge head 300. Specifically, the input/output interface 207 acquires the position of the liquid droplet discharge head 300 in the vertical direction and the like from the first control program 131 as a numerical value related to the movement of the liquid droplet discharge head 300. The processor 215A controls the input/output interface 207A to acquire the printing rate of the liquid droplet discharge head 300. To be more specific, the input/output interface 207A acquires the printing rate of the liquid droplet discharge head 300 from the second control program 132.

The processor 215A adjusts the supply pressure and the recovery pressure to keep constant the circulation pressure (pressures) of the liquid inside the liquid droplet discharge heads 300, the circulation pressure of the liquid changing depending on the acquired position of the liquid droplet discharge head 300. The method of controlling the first proportional valve 204 and the second proportional valve 205 based on the position of the liquid droplet discharge head 300 and the like is the same as or similar to the method of controlling illustrated in FIG. 9 to FIG. 11.

The processor 215A adjusts the supply pressure and the recovery pressure to keep constant the circulation pressure (pressures) of the liquid inside the liquid droplet discharge heads 300, the circulation pressure of the liquid changing according to the acquired printing rate of the liquid droplet discharge head 300. In order to keep the circulation pressure (pressure) of the liquid inside the liquid droplet discharge head 300 constant, both the supply pressure and the recovery pressure need to be increased to compensate for the insufficient supply of the liquid. The processor 215A refers to the second pressure adjustment information 243A to determine the adjustment value for the supply pressure and the adjustment value for the recovery pressure corresponding to the acquired printing rate of the liquid droplet discharge head 300. The adjustment value for the supply pressure and the adjustment value for the recovery pressure increase consistently with the printing rate of the liquid droplet discharge head 300. While referring to the measurement result of the third pressure sensor 210, the processor 215A increases the flow rate of the fluid passing through the first proportional valve 204 by widening the channel cross-sectional area of the first proportional valve 204 in order to increase the supply pressure to a target pressure based on the determined adjustment value. On the other hand, while referring to the measurement result of the fourth pressure sensor 211, the processor 215A increases the flow rate of the fluid passing through the second proportional valve 205 by widening the channel cross-sectional area of the second proportional valve 205 in order to increase the recovery pressure to a target pressure based on the determined adjustment value.

This allows the processor 215A to increase or reduce the flow rate of the fluid passing through the first proportional valve 204 and the second proportional valve 205 in accordance with the printing rate of the liquid droplet discharge head 300. As a result, the processor 215A can keep the circulation pressure (pressure) of the liquid inside the liquid droplet discharge head 300 constant.

An example of a processing procedure of the liquid droplet discharge system 1 according to another embodiment will be described using FIG. 15. FIG. 15 is a flowchart illustrating an example of the processing procedure of the liquid droplet discharge system according to such another embodiment. The processing illustrated in FIG. 15 is executed by the processor 215A. The processing illustrated in FIG. 15 is repeatedly executed during the operation of the liquid droplet discharge system 1.

As illustrated in FIG. 15, the processor 215A controls the input/output interface 207A to acquire, from the first control program 131, a numerical value related to the movement of the liquid droplet discharge head 300 (step S201). That is, the input/output interface 207A acquires, as the numerical value, at least one selected from the group consisting of the position of the liquid droplet discharge head 300 in the vertical direction, the vertical acceleration acting on the liquid droplet discharge head 300, and the horizontal acceleration acting on the liquid droplet discharge head 300.

The processor 215A controls the input/output interface 207A to acquire the printing rate of the liquid droplet discharge head 300 from the second control program 132 (step S202).

The processor 215A refers to the first pressure adjustment information 242A to determine the adjustment values for the supply pressure and recovery pressure corresponding to the acquired numerical value (step S203).

Then, the processor 215A adjusts, to the determined adjustment values, the supply pressure and the recovery pressure of the liquid circulating between the tank 201 and the liquid droplet discharge head 300 (step S204), and returns to the processing procedure of the step S201.

The processor 215A performs the processing procedure of steps S205 to S206 based on the printing rate of the liquid droplet discharge head 300 while overlapping with the processing procedure of steps S203 to S204 based on the numerical value related to the operation of the liquid droplet discharge head 300.

That is, the processor 215A refers to the second pressure adjustment information 243A to determine the adjustment value for the supply pressure and the adjustment value for the recovery pressure corresponding to the acquired printing rate of the liquid droplet discharge head 300 (step S205).

The processor 215A adjusts the supply pressure and the recovery pressure of the liquid circulating between the tank 201 and the liquid droplet discharge head 300 to the determined adjustment value (step S206), and returns to the processing procedure of the step S201.

Note that, when the numerical value acquired in step S201 is smaller than a predetermined value, the processor 215A can determine that no hydraulic head pressure sufficient to affect the circulation pressure of the liquid circulating through the liquid droplet discharge head 300 has been generated. In this case, the processor 215A may stop the adjustment of the supply pressure and the recovery pressure based on the numerical value related to the operation of the liquid droplet discharge head 300 (the processing procedure of steps S203 to S204). That is, the processor 215A performs only the adjustment of the supply pressure and the recovery pressure based on the printing rate of the liquid droplet discharge head 300 (the processing procedure of steps S205 to S206) when no hydraulic head pressures sufficient to affect the circulation pressure of the liquid circulating through the liquid droplet discharge head 300 has been generated. Thus, the circulation pressure (pressure) of the liquid inside the liquid droplet discharge head 300 can be kept constant while suppressing an increase in the processing load.

As illustrated in FIG. 6 and FIG. 7, the liquid droplet discharge system 1 may use the flowmeter 212 connected to the first channel RT1 to measure the flow rate of the liquid supplied to the liquid droplet discharge head 300, and compare the measured flow rate of the liquid with the discharge amount obtained from the printing rate. When the discharge amount obtained from the printing rate is larger than the flow rate of the liquid measured by the flowmeter 212, the liquid droplet discharge system 1 may adjust the supply pressure and the recovery pressure so as to not increase or to decrease the circulation pressure.

To be specific, when determining the adjustment value for the supply pressure and the adjustment value for the recovery pressure corresponding to the acquired printing rate of the liquid droplet discharge head 300 (step S205), the processor 215A obtains the discharge amount assumed from the printing rate and also acquires the flow rate of the liquid measured by the flowmeter 212. Then, the processor 215A compares the discharge amount obtained from the printing rate with the flow rate of the liquid measured by the flowmeter 212. When the discharge amount obtained from the printing rate is larger than the flow rate of the liquid measured by the flowmeter 212, the processor 215A may control the first and second proportional valves 204 and 205 so as to not increase the circulation pressure or to decrease the circulation pressure.

For example, in the liquid droplet discharge head 300, the discharge amount may be reduced due to non-discharge of liquid droplets caused by bubbles or foreign matter in many channels (discharge holes 305h). In such a case, although the actual discharge amount is small, the circulation pressure may be adjusted to increase based on the information of the printing rate (see S205 and S206 in FIG. 15). Note that, as described above with reference to FIG. 1, the printing rate refers to, for example, the ratio (S1/S2) of the integrated area S1 of the liquid discharged onto the object 50 to the area S2 of the spraying surface 50SF of the object 50. As a result, the internal pressure of the liquid droplet discharge head 300 becomes inappropriately high, which may cause problems such as ink overflowing from the discharge hole 305h. In order to mitigate such a problem, the expected discharge amount is calculated from the printing rate, and the value of the expected discharge amount is compared with the measurement value of the flowmeter 212. When the value of the expected discharge amount is larger than the measurement value of the flowmeter 212, the circulation pressure is preferably caused to not increase or to decrease.

Note that only circulation is performed when no discharge is present, the discharge amount assumed from the printing rate is normally smaller than the measurement value of the flowmeter 212. Since the measurement value of the flowmeter 212 is the sum of the discharge amount and the circulation flow rate during discharge, the discharge amount assumed from the printing rate is normally smaller than the measurement value of the flowmeter 212. On the other hand, a state in which the discharge amount obtained from the printing rate as described above is larger than the flow rate measured by the flowmeter 212 is an abnormal state.

As described above, the coating apparatus (for example, the liquid droplet discharge system 1) according to the embodiment includes a reserve portion (for example, the tank 201), a robot unit (for example, the robotic arm 100), a first channel (for example, the first channel RT₁), a second channel (for example, the second channel RT₂), an acquiring unit (for example, the input/output interface 207 or 207A), and a controller (for example, the processor 215 or 215A). The reserve portion stores liquid to be supplied to the liquid droplet discharge portion (for example, the liquid droplet discharge head 300). The robot unit operates the liquid droplet discharge portion. The first channel is a channel through which the reserve portion and the liquid droplet discharge portion are in communication with each other, the channel being configured to cause the liquid reserved in the reserve portion to flow into the liquid droplet discharge portion. The second channel is a channel through which the reserve portion and the liquid droplet discharge portion are in communication with each other, the channel being configured to cause the liquid having flowed into the liquid droplet discharge portion to flow back to the reserve portion. The acquiring unit acquires information on the operation of the liquid droplet discharge portion from a program (for example, the first control program 131) controlling the operation of the robot unit. The controller controls a circulation pressure of the liquid circulating between the reserve portion and the liquid droplet discharge portion. The controller controls the circulation pressure based on the information related to the operation. Thus, according to the coating apparatus of the embodiment, even when the circulation pressure of the liquid supplied to the liquid droplet discharge portion is affected by the operation of the liquid discharge portion by the robot unit, the circulation pressure can be appropriately maintained.

The coating apparatus according to the embodiment may further include a first valve portion (for example, the first proportional valve 204), a second valve portion (for example, the second proportional valve 205), a first pressure measuring portion (for example, the third pressure sensor 210), and a second pressure measuring portion (for example, the fourth pressure sensor 211). The first valve portion may be interposed in the first channel and may control the flow rate of the liquid fed from the reserve portion to the liquid droplet discharge portion. The second valve portion may be interposed in the second channel and may control the flow rate of the liquid fed from the liquid droplet discharge portion to the reserve portion. The first pressure measuring portion may measure, through the first channel, the fluid pressure of the liquid flowing between the first valve portion and the liquid droplet discharge portion as a supply pressure. The second pressure measuring portion may measure, through the second channel, the fluid pressure of the liquid flowing between the second valve portion and the liquid droplet discharge portion as a recovery pressure. The acquiring unit may acquire the numerical value related to the movement of the liquid droplet discharge portion from a program controlling the operation of the robot unit. The controller may control the first valve portion and the second valve portion based on a numerical value acquired by the acquiring unit, and may adjust the supply pressure and the recovery pressure. Thus, according to the coating apparatus of the embodiment, even when the circulation pressure of the liquid supplied to the liquid droplet discharge portion is affected by the movement of the liquid discharge portion by the robot unit, the circulation pressure can be appropriately maintained.

The acquiring unit may acquire the position of the liquid droplet discharge portion in the vertical direction as a numerical value. The controller may adjust the supply pressure and the recovery pressure to keep constant the pressure of the liquid inside the liquid droplet discharge portion, the pressure of the liquid changing depending on the position. For example, the adjustment value for the supply pressure and the adjustment value for the recovery pressure may increase with increase in height of the position. Thus, even when the liquid circulating through the liquid droplet discharge portion is affected by the hydraulic head pressure due to a change in the position of the liquid droplet discharge portion in the vertical direction, the coating apparatus according to the embodiment can adjust the supply pressure and the recovery pressure of the liquid to cancel the effect of the hydraulic head pressure.

The acquiring unit may acquire, as the numerical value, the vertical acceleration acting on the liquid droplet discharge portion. The controller may adjust the supply pressure and the recovery pressure to keep constant the pressure of the liquid inside the liquid droplet discharge portion, the pressure of the liquid changing according to the vertical acceleration. For example, the adjustment value for the supply pressure and the adjustment value for the recovery pressure may decrease with increase in the vertically upward acceleration. As a result, the coating apparatus according to the embodiment can adjust the supply pressure and the recovery pressure of the liquid in such a manner that even when the liquid circulating through the liquid droplet discharge portion is affected by hydraulic head pressure due to a change in the vertical acceleration acting on the liquid droplet discharge portion, the effect of the hydraulic head pressure is canceled out.

The acquiring unit may acquire the horizontal acceleration acting on the liquid droplet discharge portion as the numerical value. The controller may adjust the supply pressure and the recovery pressure to keep constant the pressure of the liquid inside the liquid droplet discharge portion, the pressure of the liquid changing depending on the horizontal acceleration. For example, the adjustment value for the supply pressure may decrease with increase in the acceleration in a direction from a downstream side to an upstream side of the liquid flowing inside the liquid droplet discharge portion. For example, the adjustment value for the recovery pressure may increase with increase in the acceleration in the direction from the downstream side to the upstream side of the liquid flowing inside the liquid droplet discharge portion. For example, the coating apparatus according to the embodiment can adjust the supply pressure and the recovery pressure of the liquid in such a manner that even when the liquid circulating through the liquid droplet discharge portion is affected by the hydraulic head pressure due to a change in the horizontal acceleration acting on the liquid droplet discharge portion, the effect of the hydraulic head pressure can be canceled out.

The coating apparatus according to the embodiment may further include a storage (for example, the storage 214). The storage may store pressure adjustment information (for example, the pressure adjustment information 242) in which the adjustment value for the supply pressure and the adjustment value for the recovery pressure for suppressing a change in the pressure of the liquid inside the liquid droplet discharge portion is associated with the numerical value for each of magnitudes of the numerical value. With reference to the pressure adjustment information, the controller may adjust the supply pressure and the recovery pressure to the adjustment values corresponding to the numerical value acquired by the acquiring unit. As a result, the coating apparatus according to the embodiment can adjust the supply pressure and the recovery pressure of the liquid in such a manner that even when the liquid circulating through the liquid droplet discharge portion is affected by the hydraulic head pressure due to a change in any of various numeral values related to the movement of the liquid droplet discharge portion, the effect of the hydraulic head pressure is canceled out.

The acquiring unit (for example, the input/output interface 207A) may further acquire a printing rate of the liquid droplet discharge portion from a program (for example, the second control program 132) controlling an operation, related to the discharge, of the liquid droplet discharge portion. The controller (for example, the processor 215A) may adjust the supply pressure and the recovery pressure based on the numerical value acquired by the acquiring unit and may adjust the supply pressure and the recovery pressure based on the printing rate acquired by the acquiring unit. Thus, the coating apparatus of the embodiment can appropriately maintain the circulation pressure even when the circulation pressure of the liquid supplied to the liquid droplet discharge portion is affected by the movement of the liquid discharge portion caused by the robot unit or the printing rate of the liquid droplet discharge portion.

The controller may adjust the supply pressure and the recovery pressure to keep constant the pressure of the liquid inside the liquid droplet discharge portion, the pressure of the liquid changing depending on the printing rate of the liquid droplet discharge portion. For example, the adjustment value for the supply pressure and the adjustment value for the recovery pressure may increase with increase in the printing rate of the liquid droplet discharge portion. As a result, the coating apparatus according to the embodiment can adjust the supply pressure and the recovery pressure of the liquid to compensate for the insufficient supply of the liquid due to a change in the printing rate of the liquid droplet discharge head.

The coating apparatus according to the embodiment may further include a storage (for example, the storage 214A). The storage may store first pressure adjustment information (for example, the first pressure adjustment information 242A) in which adjustment value for the supply pressure and the adjustment value for the recovery pressure for suppressing a change in the pressure of the liquid inside the liquid droplet discharge portion are associated with the numerical value for each of magnitudes of the numerical value, and second pressure adjustment information (for example, the second pressure adjustment information 243A) in which the adjustment value for the supply pressure and the adjustment value for the recovery pressure for suppressing a change in the pressure of the liquid inside the liquid droplet discharge portion are associated with the printing rate of the liquid droplet discharge portion for each of magnitudes of the printing rate. With reference to the first pressure adjustment information, the controller (for example, the processor 215A) may adjust the supply pressure and the recovery pressure to the adjustment values corresponding to the numerical value acquired by the acquiring unit. At the same time, the controller may refer to the second pressure adjustment information to adjust the supply pressure and the recovery pressure to the adjustment value corresponding to the printing rate acquired by the acquiring unit. Thus, the coating apparatus of the embodiment can perform the adjustment of the supply pressure and the recovery pressure based on any of various numerical values related to the movement of the liquid droplet discharge portion in parallel with the adjustment of the supply pressure and the recovery pressure based on the printing rate of the liquid droplet discharge portion.

When the numerical value acquired by the acquiring unit is smaller than a predetermined threshold value, the controller may stop the adjustment of the supply pressure and the recovery pressure based on the numerical value. Thus, the coating apparatus of the embodiment can appropriately maintain the circulation pressure while suppressing an increase in the processing load.

Further effects and other embodiments can be readily derived by those skilled in the art. Thus, a wide variety of aspects of the present invention are not limited to the specific details and representative embodiments represented and described above. Accordingly, various changes can be made without departing from the spirit or scope of the general inventive concepts defined by the appended claims and their equivalents.

1. A coating apparatus comprising:
a reserve portion configured to reserve a liquid to be supplied to a liquid droplet discharge portion;
a robot unit configured to perform an operation of the liquid droplet discharge portion;
a first channel through which the reserve portion and the liquid droplet discharge portion are in communication with each other, the first channel being configured to cause the liquid reserved in the reserve portion to flow into the liquid droplet discharge portion;
a second channel through which the reserve portion and the liquid droplet discharge portion are in communication with each other, the second channel being configured to cause the liquid having flowed into the liquid droplet discharge portion to return to the reserve portion;
an acquiring unit configured to acquire information related to the operation of the liquid droplet discharge portion from a program controlling an operation of the robot unit; and
a controller configured to control a circulation pressure of the liquid circulating between the reserve portion and the liquid droplet discharge portion,
wherein the controller is configured to control the circulation pressure, based on the information related to the operation.

2. The coating apparatus according to claim 1, further comprising:
a first valve portion interposed in the first channel and configured to control a flow rate of the liquid fed from the reserve portion to the liquid droplet discharge portion;
a second valve portion interposed in the second channel and configured to control a flow rate of the liquid fed from the liquid droplet discharge portion to the reserve portion;
a first pressure measuring portion configured to measure a fluid pressure of the liquid flowing between the first valve portion and the liquid droplet discharge portion through the first channel as a supply pressure; and
a second pressure measuring portion configured to measure a fluid pressure of the liquid flowing between the second valve portion and the liquid droplet discharge portion through the second channel as a recovery pressure,
wherein the acquiring unit is configured to acquire a numerical value related to movement of the liquid droplet discharge portion from the program controlling the operation of the robot unit, and
the controller is configured to control the first valve portion and the second valve portion based on the numerical value acquired by the acquiring unit to adjust the supply pressure and the recovery pressure.

3. The coating apparatus according to claim 2, wherein
the acquiring unit is configured to
acquire a position of the liquid droplet discharge portion in a vertical direction as the numerical value, and
the controller is configured to
adjust the supply pressure and the recovery pressure to keep constant the pressure of the liquid inside the liquid droplet discharge portion, the pressure of the liquid changing depending on the position.

4. The coating apparatus according to claim 3, wherein
an adjustment value for the supply pressure and an adjustment value for the recovery pressure increase with increase in height of the position.

5. The coating apparatus according to claim 2, wherein
the acquiring unit is configured to
acquire a vertical acceleration acting on the liquid droplet discharge portion as the numerical value, and
the controller is configured to
adjust the supply pressure and the recovery pressure to keep constant the pressure of the liquid inside the liquid droplet discharge portion, the pressure of the liquid changing according to the vertical acceleration.

6. The coating apparatus according to claim 5, wherein
the adjustment value for the supply pressure and the adjustment value for the recovery pressure decrease with increase in the vertical upward acceleration.

7. The coating apparatus according to claim 2, wherein
a horizontal acceleration acting on the liquid droplet discharge portion is acquired as the numerical value, and
the controller is configured to
adjust the supply pressure and the recovery pressure to keep constant the pressure of the liquid inside the liquid droplet discharge portion, the pressure of the liquid changing depending on the horizontal acceleration.

8. The coating apparatus according to claim 7, wherein
the adjustment value for the supply pressure decreases with increase in the acceleration in a direction from a downstream side to an upstream side of the liquid flowing inside the liquid droplet discharge portion, and
the adjustment value for the recovery pressure increases with increase in the acceleration in the direction from the downstream side to the upstream side of the liquid flowing inside the liquid droplet discharge portion.

9. The coating apparatus according to claim 2, further comprising:
a storage configured to store pressure adjustment information in which an adjustment value for the supply pressure and an adjustment value for the recovery pressure for suppressing a change in the pressure of the liquid inside the liquid droplet discharge portion are associated with the numerical value for each of magnitudes of the numerical value,
wherein the controller is configured to
adjust, with reference to the pressure adjustment information, the supply pressure and the recovery pressure to the adjustment values corresponding to the numerical value acquired by the acquiring unit.

10. The coating apparatus according to claim 2, wherein
the acquiring unit is configured to further acquire a printing rate of the liquid droplet discharge portion from a program controlling an operation, related to discharge, of the liquid droplet discharge portion, and
the controller is configured to
adjust the supply pressure and the recovery pressure based on the numerical value acquired by the acquiring unit, and adjust the supply pressure and the recovery pressure based on the printing rate acquired by the acquiring unit.

11. The coating apparatus according to claim 10, wherein
the controller is configured to
adjust the supply pressure and the recovery pressure to keep constant the pressure of the liquid inside the liquid droplet discharge portion, the pressure of the liquid changing depending on the printing rate of the liquid droplet discharge portion.

12. The coating apparatus according to claim 11, wherein
the adjustment value for the supply pressure and the adjustment value for the recovery pressure increase with increase in the printing rate of the liquid droplet discharge portion.

13. The coating apparatus according to claim 10, further comprising:
a storage configured to store first pressure adjustment information in which an adjustment value for the supply pressure and an adjustment value for the recovery pressure for suppressing a change in the pressure of the liquid inside the liquid droplet discharge portion are associated with the numerical value for each of magnitudes of the numerical value, and second pressure adjustment information in which the adjustment value for the supply pressure and the adjustment value for the recovery pressure for suppressing a change in the pressure of the liquid inside the liquid droplet discharge portion are associated with the printing rate of the liquid droplet discharge portion for each of magnitudes of the printing rate, wherein
the controller is configured to
adjust, with reference to the first pressure adjustment information, the supply pressure and the recovery pressure to the adjustment values corresponding to the numerical value acquired by the acquiring unit, and
adjust, with reference to the second pressure adjustment information, the supply pressure and the recovery pressure to the adjustment values corresponding to the printing rate acquired by the acquiring unit.

14. The coating apparatus according to claim 10, wherein
the controller is configured to
stop, when the numerical value acquired by the acquiring unit is smaller than a predetermined threshold value, adjustment of the supply pressure and the recovery pressure based on the numerical value.

15. The coating apparatus according to claim 10, comprising:
a flowmeter connected to the first channel and configured to measure a flow rate of the liquid fed to the liquid droplet discharge portion,
wherein the acquiring unit is configured to acquire the flow rate of the liquid measured by the flowmeter, and
the controller is configured to, when a discharge amount calculated from the printing rate is larger than a flow rate of the liquid measured by the flowmeter, adjust the supply pressure and the recovery pressure to not increase the circulation pressure or to decrease the circulation pressure.

16. A coating method in a coating apparatus, the coating apparatus comprising:
a reserve portion configured to reserve a liquid to be supplied to a liquid droplet discharge portion;
a robot unit configured to perform an operation of the liquid droplet discharge portion;
a first channel through which the reserve portion and the liquid droplet discharge portion are in communication with each other, the first channel being configured to cause the liquid reserved in the reserve portion to flow into the liquid droplet discharge portion;
a second channel through which the reserve portion and the liquid droplet discharge portion are in communication with each other, the second channel being configured to cause the liquid having flowed into the liquid droplet discharge portion to return to the reserve portion; and
an acquiring unit configured to acquire information related to the operation of the liquid droplet discharge portion from a program controlling an operation of the robot unit,
the coating method comprising:
controlling a circulation pressure of the liquid circulating between the reserve portion and the liquid droplet discharge portion,
wherein the controlling controls the circulation pressure, based on information related to the operation.
